(19) United States
(12) Patent Application Publication
(10) Pub. No.: US 2003/0212788 A1
(43) Pub. Date: Nov. 13, 2003

(54) Generic control interface with multi-level status

(75) Inventors: Mark F. Wilding, Barrie (CA); Steven Raspudic, Mississauga (CA)

Correspondence Address: Jeffrey S. LaBaw, International Business Machines, Intellectual Property Law, Austin, TX, 78758, US

(73) Assignee: INTERNATIONAL BUSINESS MACHINES CORPORATION, ARMONK, NY

(21) Appl. No.: 10/401,413

(22) Filed: Mar. 27, 2003

(30) Foreign Application Priority Data
Apr. 29, 2002 (CA) 2,383,881

(51) Int. Cl. G06F 15/173

(52) U.S. Cl. 709/224; 709/223

(57) ABSTRACT

A generic control interface for creating a control module for a service. The interface includes a facility that encapsulates the specific control commands or actions for the service in generic functions. A control module inherits or incorporates the generic functions and provides an interface between a specific service and the controlling product, thereby enabling the controlling product to control a specific service using generic functions. The functions may include a multi-level status check function, a health probe function and a customizable control or request function. The multi-level status check function assess the service's operability, aliveness and availability. A controlling product can control or monitor the service through the service's associated control module without requiring a detailed understanding of the specific operations necessary for controlling or monitoring the specific service.

### FIELD OF THE INVENTION

The present invention relates to computer systems and, in particular, to an interface for monitoring and controlling a service.

### BACKGROUND OF THE INVENTION

Users of computer technology are increasingly concerned with maintaining high availability of critical applications. This is especially true of enterprise users that provide a computer-implemented service or interface to customers. Maintaining continuous operation of the computer system is of growing importance for many businesses. Some estimates place the cost to United States businesses of system downtime at $4.0 billion per year.

The reasons for software failure fall into at least two categories. First, the software product may fail if the system resources become inadequate for the needs of the software product. This problem may be characterized as an inadequate or unhealthy operating environment. Second, even in a healthy operating environment, a software product may fail due to software defects, user error or other causes unrelated to the operating environment resources.

There are existing stand-alone monitoring products which monitor the operating system to gather data regarding system performance and resource usage. This information is typically displayed to the user upon request, usually in a graphical format, so that the user can visually assess the health of the operating environment during operation of one or more applications or services.

There are also existing fault monitors for use in a clustering environment that will identify a failed system, application or service and will restart the application or service or will move the application or service to another system in the cluster. Clustered environments are the most common approach to providing greater availability for critical applications or services. However, clustering technology tends to be complex, difficult to configure, and uses expensive proprietary technology. A clustered environment fails to provide adequate availability for various reasons, including the increased amount of hardware which increases the potential for hardware failure, the unfamiliarity of clustering to most system administrators, instability in the clustering software itself which will cause failure of the entire cluster, and network or communication problems.

To control and monitor a service, developers of controlling products are required to incorporate control functions or actions specific to the service being controlled. Accordingly, great time and effort can go into developing a controlling product that accommodates all anticipated services that may need to be controlled or monitored. Alternatively, the controlling product is limited to controlling a very small number of services.

There are conventional monitoring interfaces for monitoring a service, however these interfaces are typically limited to determining whether a service is alive and whether it is available. Known control interfaces provide only limited capability to start a service, stop a service or kill an instance of a service.

### BRIEF SUMMARY OF THE INVENTION

The present invention provides a generic control interface that permits the encapsulation of control and monitoring actions for a particular service in an associated control module created using a generic control facility, thereby permitting any controlling product to monitor or control the service without the necessity of understanding the specific actions necessary to control the service.

In one aspect, the present invention provides a control module for use by a controlling product in controlling or monitoring a service on a computer system. The control module includes a plurality of functions, including a multi-level status check function for determining a level of availability of the service and assigning a status indicator of the level of availability, the status indicator having at least three levels.

In another aspect, the present invention provides a control module for use by a controlling product in controlling or monitoring a service on a computer system, the control module including a plurality of functions including a health probe function for testing an aspect of the functionality of the service, said health probe function including an instruction to the service to perform an operation, and a return parameter that indicates the success of said operation.

In yet another aspect, the present invention provides a control module for use by a controlling product in controlling or monitoring a service on a computer system, the control module including a plurality of functions including a request function for requesting a specific action by the service, the request function including an instruction to the service to perform a specific action and a response parameter containing the results of the specific action.

In another aspect, the present invention provides a method for controlling or monitoring a service by a controlling product on a computer system, the computer system including a control module having a plurality of functions including a multi-level status check function, the method comprising the steps of determining a level of availability of the service, and assigning a status indicator of the level of availability, the status indicator having at least three levels.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show a preferred embodiment of the present invention, and in which:

FIG. 1 shows a block diagram of a system according to the present invention;

FIG. 2 shows a flowchart of a probe calling method for a fault monitor according to the present invention;

FIG. 3 shows a flowchart for the operation a system monitor according to the present invention;

FIG. 4 shows a flowchart of a method of operation of a fault monitor according to the present invention;

FIG. 5 shows a flowchart of a method of operation of a fault monitor coordinator according to the present invention; and

FIG. 6 shows a block diagram of a generic control interface, according to the present invention, including a control module created from a generic control facility.

### DETAILED DESCRIPTION OF THE PREFERRED EMBODIMENTS

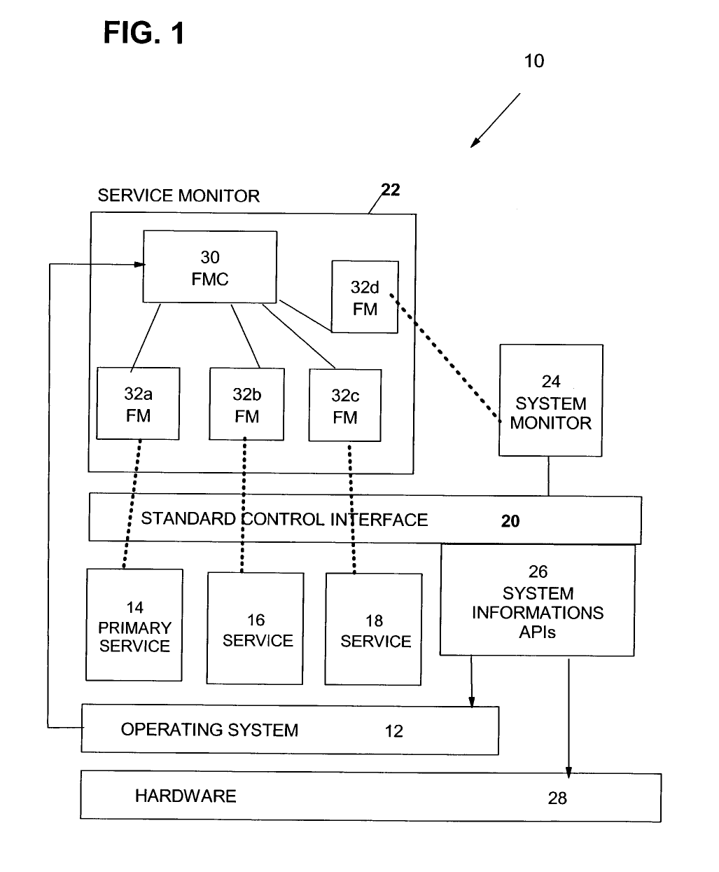

Reference is first made to FIG. 1 which shows a block diagram of a system 10 according to the present invention. The system 10 is embodied within a general purpose computer or computers, clustered or unclustered. The computer(s) include hardware 28 and an operating system 12. Functioning or running upon the operating system 12 are one or more services. One of the services is a primary service 14, which comprises the main application program or software product that is required by a user, for example the DB2™ application program. The primary service 14 may employ other services denoted by references 16 and 18 to assist in performing its functions. For example, the primary service 14 such as the DB2™ application may employ an internet browser service such as the Netscape Navigator™ product or the Microsoft Internet Explorer™ product as a part of its functionality. In addition, there may be application programs or services (not shown) operating upon the system 10 that are not used in conjunction with the primary service 14.

Also functioning upon the operating system 12 are a service monitor 22 and a system monitor 24. The service monitor 22 monitors the primary service 14 and any of the associated services 16 and 18, including the system monitor 24. The system monitor 24 monitors the operating environment through system information application program interfaces, or APIs 26, which provide status information regarding the operating system 12 and the system hardware 28. In one embodiment, the system information APIs 26 are provided by a standard control interface 20.

The service monitor 22 ensures that the primary service 14 and its associated services 16 and 18 continue to function within prescribed parameters. In the event that the service monitor 22 detects abnormalities in the operation of the primary service 14 or its associated services 16 and 18, such as a program crash, program freeze or other error, the service monitor 22 takes corrective action. Such corrective action may include generating and sending an alert to a system administrator, restarting the failed service, and other actions, as will be described in greater detail below.

In addition to monitoring the primary service 14 and its associated services 16 and 18, the service monitor 22 also monitors the system monitor 24 to ensure it continues to function within prescribed parameters. The service monitor 22 will take corrective action in the event that the system monitor 24 malfunctions.

The system monitor 24 assesses the availability of resources in the operating environment that are required by the primary service 14. Examples of the resources that may be monitored are processor load, hard disk space, virtual memory space, RAM and other resources. The system monitor 24 monitors these resources and assesses their availability against prescribed parameters for safe operation of the primary service 14 and its associated services 16 and 18. If the system monitor 24 determines that a resource's availability has fallen below a prescribed parameter, then the system monitor 24 may take corrective action. Such corrective action may include generating and sending an alert to a system administrator, adjusting the operation of the primary service 14 such that fewer resources are required, adding additional resources, terminating the operation of one or more other application programs or services, and other acts.

In one embodiment, the system 10 further includes a system registry 25. The system registry 25 provides the system monitor 24 with the prescribed parameters against which the system resources are to be evaluated.

The service monitor 22 may include a fault monitor coordinator (FMC) 30 and various dedicated fault monitors (FM) 32, indicated individually by references 32a, 32b, 32c and 32d in FIG. 1. An instance of a fault monitor 32 is created for each instance of a service 14, 16, 18 and 24 that the service monitor 22 oversees. Each individual fault monitor 32 has responsibility for monitoring the instance of a single service. In the event that a fault monitor 32 detects an abnormality in the service (i.e. 14, 16, 18 or 24) that it is monitoring, the fault monitor 32 takes corrective action. The fault monitor coordinator 30 manages the creation and coordination of the various fault monitors 32 and ensures that the fault monitors 32 continue to operate. Collectively, the fault monitor coordinator 30 and the fault monitors 32 monitor the services on the system 10 to ensure that they remain alive and available.

According to this aspect, the service monitor 22 and the system monitor 24 ensure the high availability of the primary service 14 and its associated services 16 and 18 through monitoring the services themselves 14, 16 and 18 and the availability of operating environment resources. In order to ensure the availability of the service monitor 22 to perform this function, the operating system 12 ensures that the fault monitor coordinator 30 is operational. Typically, the operating system 12 provides a facility that can be configured to restart a service in the event of an unexpected failure. This facility can be employed to ensure that the fault monitor coordinator 30 is restarted in the event of an unexpected failure. For example, the Microsoft Windows 2000™ operating system permits the creation of service applications and service control managers. The service control manager in the Microsoft Windows 2000™ operating system is designed to monitor the service application for failures and can perform specific behaviours in the event of a failure, including restarting the service application. Accordingly, the fault monitor coordinator 30 may be created as a service application and a corresponding service control manager may be created for restarting the service application in the event of a failure. In this manner, the operating system 12 ensures the availability of the fault monitor coordinator 30, which, in turn, ensures the availability of the fault monitors 32. The individual fault monitors 32 ensure the availability of the system monitor 24 and the services. As a further example, with the Unix™ operating system the init daemon feature can be used to start and restart the fault monitor coordinator 30.

The system 10 also includes a service registry 31 that is accessible to the service monitor 22. The service registry 31 contains information used by the service monitor 22, such as which services to start-up and which services to monitor. In one embodiment, the service registry 31 includes an entry for each instance of a service that is to be made available. Each service registry entry includes the name of the service, the path to its installation directory and an associated control module created using the standard control interface 20. Each service registry entry also has a unique identifier, so as to enable distinctions between separate instances of the same service. In one embodiment, the unique identifier is the user name of the instance. A service registry entry may also include user login information and instructions regarding whether the service should be started at boot time or only maintained available once the user has initiated the service. The service registry 31 may be stored on disk, in memory or in any location accessible to the service monitor 22. When the fault monitor coordinator 30 is started, it checks the service registry 31 to identify the instances of services that should be made available. For each such instance of a service, the fault monitor coordinator 30 then creates a fault monitor 32 to start and monitor the instance of a service.

The fault monitor coordinator 30 and the fault monitors 32 employ the standard control interface 20 for performing monitoring and corrective functions. In addition to providing monitoring capabilities, the standard control interface 20 should be able to stop a service, start a service, kill an unhealthy or unresponsive service and perform clean-up, such as flushing buffers and removing leftover resources used by the service. The specific tasks preformed by the standard control interface 20, for example in a clean-up call, will be particular to a service and may be customized to each service. The fault monitors 32 are unaware of the operations involved in implementing the calls, such as what tasks are performed in a clean-up call for a specific service. Accordingly, the fault monitors 32 are flexible and may be employed with any primary service 14 and associated services 16 and 18. For a specific implementation, only the details of the standard control interface 20 calls as applied to each service need be customized. In one embodiment, the standard control interface 20 provides a customized associated control module for each particular service. The service registry provides the fault monitor coordinator 30 with information regarding where to find the associated control module for a particular service, and the fault monitor coordinator 30 passes this information on to the individual fault monitor 32.

In one embodiment, the standard control interface 20 provides two methods of monitoring a service and ensuring its health. The first method is to assess the status of the service. The second method is to perform custom probes. These methods are described in further detail below.

To obtain the status of a monitored service, a fault monitor 32 calls a status checking function defined by the standard control interface 20 with respect to the specific service being monitored. The standard control interface 20 uses three indicators to determine the status of a service: operability, aliveness and availability. Operability refers to the possibility that the service could be started. In almost all cases, if a service is installed on the system 10, then it is operable. Conversely, if it has not been installed, then it is not operable. In one embodiment, the operability of a service is dependent upon the existence of the command for starting the service. For example, to determine the operability of the Microsoft Internet Explorer™ application program, the standard control interface 20 could determine whether the command Iexplore.exe exists on the system 10.

Aliveness refers to whether the service has been started and is present in memory. In one embodiment, the standard control interface 20 determines if a service is alive by evaluating whether processes associated with the service are resident in memory. This evaluation indicates whether the service has been started and is present in memory on the system 10.

Availability refers to whether the service is in a “normal” mode in which it may take requests. For example, a relational database management engine may be in a maintenance mode or performing crash recovery, which renders it unavailable. Other services may have other modes in which they would be considered unavailable. The evaluation of availability by the standard control interface 20 is customized to particular services based upon their modes of operation. Some services may not have a mode other than available, in which case the standard control interface 20 may indicate that the service is available any time that it is alive.

If a service is available, it is necessarily alive and operable. Similarly, if a service is alive, it must be operable. Accordingly, there are five possible states that a service may be in, as shown in the following table:

| | Operable | Alive | Available |
|---|---|---|---|
| Not operable | no | — | — |
| Operable, not alive | yes | no | — |
| Operable, Alive, not available | yes | yes | no |
| Operable, Alive and available | yes | yes | yes |
| State unknown | — | — | — |

In response to a call from a fault monitor 32 to get the status of a service, the standard control interface 20 provides the fault monitor 32 with a response that indicates one of the five states. The fault monitor 32 understands the significance of the results of a status check and may respond accordingly. The actions of the fault monitor 32 will generally be directed to ensuring that the service is available as soon as possible. For example, if a service is alive but unavailable, the fault monitor 32 may wait a short period of time and then re-evaluate the service to determine if the service has returned to an available status, failing which it may notify the system administrator. Similarly, if a service is operable and not alive, the fault monitor 32 may start the service. Alternatively, if a service is not operable, the fault monitor 32 may send a notification to the system administrator to alert the administrator to the absence of the service. Other actions in response to a particular status result may be custom designed for a particular service.

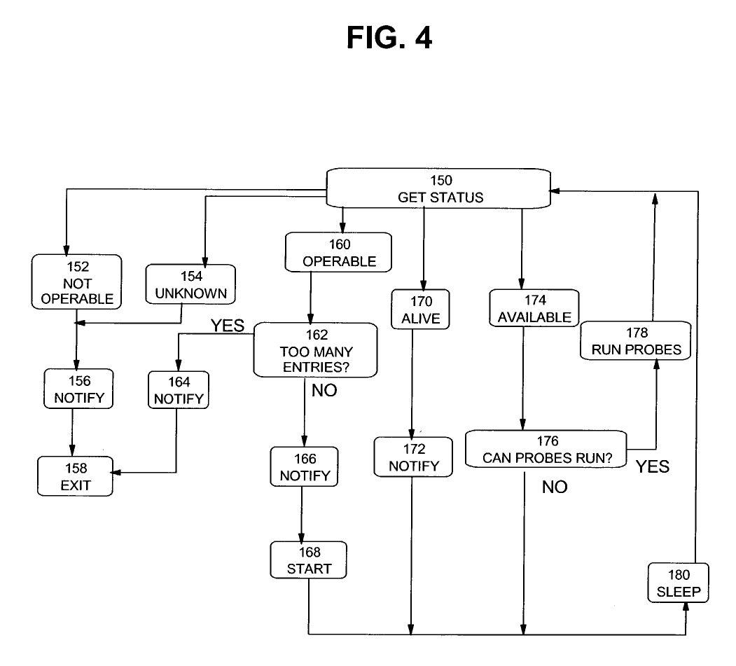

Reference is now made to FIG. 4, which shows a flowchart illustrating a method of operation of a fault monitor 32 (FIG. 1) for obtaining and responding to the status of a service. The method begins, in step 150, when the fault monitor instructs the standard control interface 20 (FIG. 1) to determine the status of the service. As discussed above, the standard control interface 20 may return one of five results: not operable 152, unknown 154, operable 160, alive 170 or available 174.

If the status of the service is not operable 152, then it is not possible to start the service. Accordingly, the fault monitor 32 (FIG. 1) cannot take any action to make the service available, so it notifies a system administrator in step 156. Similarly, if the status of the service is unknown 154, then the fault monitor is unable to determine what action it could take to make the service available, so it notifies the system administrator 156. In the case of both a non-operable 152 and an unknown 154 status, the fault monitor 32 exits 158 its status monitoring routine, following the notification of an administrator.

If the status of the service is operable 160, then the fault monitor 32 (FIG. 1) will try to start the service in step 168. The fault monitor 32 maintains a count of how many times it has tried to start an operable service and prior to step 168 it checks to see if the count exceeds a maximum number of permitted retries in step 162. The maximum number may be set based upon the context and the type of service. It may also include a time-based factor, such as a maximum number of attempted starts within the past hour, or day or week. If the maximum has been reached, then the fault monitor 32 notifies the administrator 164 that it has attempted to start the service a maximum number of times and it exits 158 its status monitoring routine. If the maximum number has not been reached, then the fault monitor 32 notifies the system administrator in step 166 that it is attempting to start the service and then it attempts to start the service in step 168. The notification sent to the system administrator in step 166 may be configured to be sent only upon the initial attempt to start the service and not with each re-attempt should a preceding attempt fail to render the service alive 170 or available 174. After an attempt to start the service 168, the fault monitor 32 sleeps 180 or pauses for a predetermined amount of time before returning to step 150 to check the status of the service again.

In the event that the status of the service is determined to be alive 170, then, in step 172, the fault monitor 32 (FIG. 1) may simply notify the administrator that the service is alive but unavailable. A service may be alive but unavailable because it is temporarily in another mode of operation in which it cannot respond to requests, such as a maintenance mode or a crash recovery mode. Accordingly, the fault monitor 32 sleeps 180 for a predetermined amount of time before returning to step 150 to check the status of the service again.

If the status of the service is available 174, then the fault monitor 32 (FIG. 1) determines whether its service is testable by health probes in step 176. If not, then the fault monitor sleeps 180 for a predetermined amount of time and returns to step 150 to re-check the status of the service to ensure it remains available. If the service is testable by health probes, then the fault monitor 32 initiates the health probes routine 178, as will be described below. Following the health probes routine 178, the fault monitor 32 returns to step 150 to continue monitoring the status of the service.

An available service is considered able to take requests, however it is not guaranteed to take requests. An available status does not completely ensure that the service is healthy. Accordingly, once a service is determined to be available, further status information is required by the fault monitor 32 (FIG. 1) to assess the health of the service.

This further information can be obtained through the use of health probe functions. Health probe functions tailored to a specific service may be created using the standard control interface 20 (FIG. 1).

In the context of the invention, health probes perform an operation to test the availability of the specific service being monitored. The probes associated with a specific service are listed in a rule set accessible to the fault monitor 32 (FIG. 1), although the fault monitor 32 need not understand what each probe does. The rule set used by the fault monitor 32 tells it what probes to call and what to do if a particular probe fails. Accordingly, each service being monitored has a custom rule set governing which probes are run for that service and what to do in the event of failure in each case.

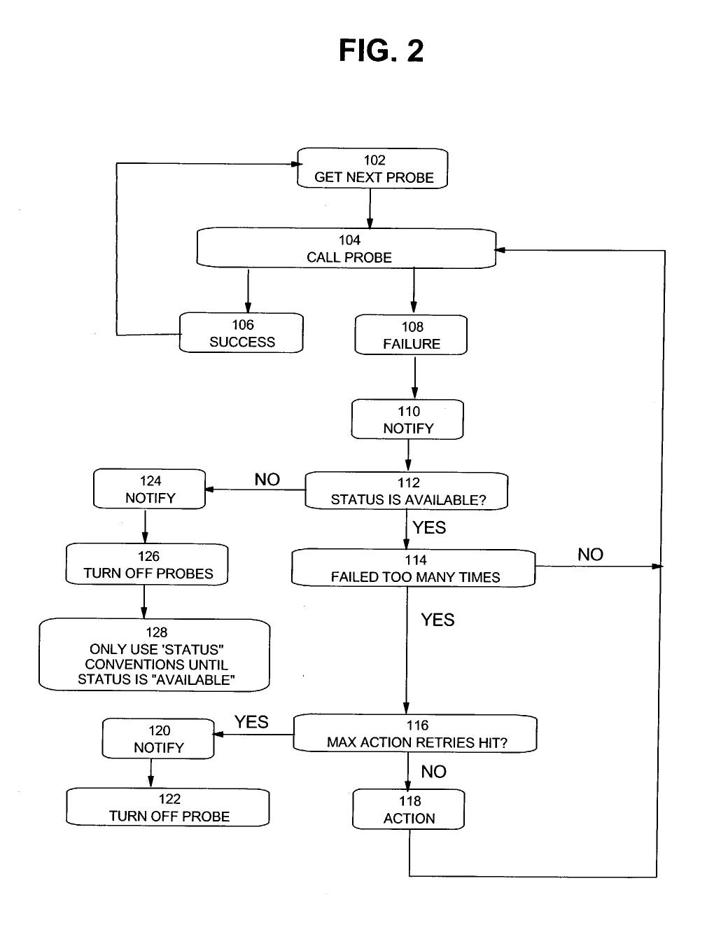

Reference is now made to FIG. 2 which shows in flowchart form a method for a calling convention for health probe functions in accordance with the present invention. The method is initiated when the fault monitor 32 (FIG. 1) receives notification from the standard control interface 20 (FIG. 1) that the service is available 174 (FIG. 4) and is testable by health probes 176 (FIG. 4). The fault monitor 32 determines the first probe function to be called with respect to the service it is monitoring by consulting the rule set associated with the service in step 102. Then in step 104, the fault monitor 32 calls the probe function. The probe function performs its operation and returns a result to the fault monitor 32 of either success 106 or failure 108. In the event of success 106, the fault monitor 32 returns to step 102 to consult the rule set to determine which probe function to call next. If no further probe functions need be called, then the fault monitor 32 enters a rest state until it is required to test the status of its service again. The fault monitor 32 may test the status of its service in scheduled periodic intervals or based upon system events, such as the start of an additional service on the system 10.

In the event that the probe function fails 108, the fault monitor 32 sends a notification 110 to the system administrator to alert the administrator to the possible availability problem on the system 10. The fault monitor 32 (FIG. 1) then re-evaluates whether the status of the service is “available” 112. If the service is still “available”, then the fault monitor 32 assesses whether it has attempted to run this probe function too often 114. The fault monitor 32 maintains a count of the number of times that it runs each probe function and assesses whether it has reached a predetermined maximum number of attempts. If it has not reached the predetermined maximum number of attempts, then the fault monitor 32 returns to step 104 and calls the probe function again. The fault monitor 32 also keeps track of the fact it sent a notification 110 to the system administrator advising that the probe failed, so that it sends this notice only initially and not each time the probe fails.

If it has reached a maximum number of attempts, then the fault monitor 32 (FIG. 1) will proceed to take a corrective action. Before taking the corrective action, the fault monitor 32 will evaluate whether it has attempted to take the corrective action too many times 116. The fault monitor 32 maintains a count of the number of times it has attempted to take corrective action based upon the failure of the probe function and assesses whether it has reached a predetermined maximum number of attempts. If it has not reached the predetermined maximum number of attempts, then the fault monitor 32 takes the corrective action in step 118. The corrective action may, for example, comprise restarting the service. Following the corrective action, the fault monitor 32 returns to step 104 to call the probe function again. The corrective action 118 may include sending a notification to the system administrator that corrective action is being attempted. As with the failure of a probe, this notice would preferably only be sent coincident with the initial attempt at corrective action, and not with each re-attempt at corrective action so as to avoid an excessive number of notices. A successful corrective action may be communicated to the system administrator in step 106 when the subsequent call of the probe function succeeds. In some cases, the predetermined maximum number of attempts for a corrective action will be limited to one.

If the fault monitor 32 (FIG. 1) tries to take the corrective action too many times and the probe function continues to fail, then the fault monitor 32 sends a notification 120 to the system administrator to alert the administrator to the failure of the corrective action. The fault monitor 32 then turns off the health probe function 122 and enters a rest state to await the next status check.

If, in step 112, the fault monitor 32 (FIG. 1) finds that the service is no longer “available”, then it sends a notice to the system administrator 124. The fault monitor 32 then turns off the use of the health probes in step 126 and sets a condition 128 that only the status method (FIG. 4) will be used until the fault monitor 32 can cause the status to return to “available”. Having terminated the probe calling routine, the fault monitor 32 enters a rest state until required to check the status of its service again.

An example of a probe function that may be utilized in connection with a service such as the Microsoft Internet Explorer™ application program is one which downloads a test webpage. Such a probe would instruct the Microsoft Internet Explorer™ browser program to open a predetermined webpage that may be expected to be available, such as a corporate homepage. If the browser is unable to load the webpage, a 404 error may be generated, which the probe function would interpret as a failure 108. Probe functions may be designed to test any other operational aspects of specific services.

One of the first services that the fault monitor coordinator 30 (FIG. 1) will create is a fault monitor 32d (FIG. 1) for is the system monitor 24 (FIG. 1). The fault monitor 32d will then start the system monitor 24. When the system monitor 24 is initially started, it will read a set of rules that provide parameters within which the operating environment resources should be maintained in order to ensure a healthy environment for the primary service 14 (FIG. 1) and its associated services 16 and 18 (FIG. 1). For example, a rule may specify that there must be 1 Megabyte of RAM available to ensure successful operation of the primary service 14 and its associated services 16 and 18.

In one embodiment, the rule set is embodied in the system registry 25 (FIG. 1), which includes a list of textual rules for various operating environment resources. Each entry includes a unique identifier of a resource, a parameter test and an action. For example, the system registry 25 may contain the following entries:

FREE_DISK_SPACE/file system “<10%” NOTIFY ADMINISTRATOR

| | |
|---|---|
| FREE_VIRTUAL_MEMORY | “<5%” RUN/opt/HBM/DB2 |

Each operating environment resource may have a unique resource identifier associated with it. The unique resource identifier may be implemented through a definition in a header file. For example, the header file may read, in part:

| | |
|---|---|
| #define OSS_ENV_FREE_VIRTUAL_MEMORY | 1 |
| #define OSS_ENV_FREE_FILE_SYSTEM_SPACE | 2 |

Some resources will require an additional identifier to ensure the resource is unique. For example, the resource “free file system space” is not unique on its own since there may be many file systems on a system. Accordingly, information may also be included about the specific file system in order to ensure that the resource identifier is unique.

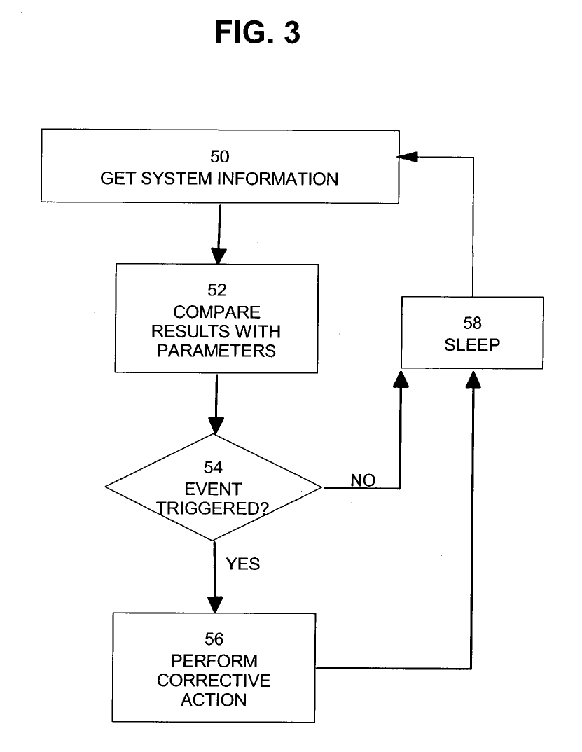

Reference is now made to FIG. 3, which shows in flowchart form the operation of the system monitor 24 (FIG. 1). The system monitor 24 begins, in step 50, by obtaining system information regarding the operating system 12 and the hardware 28 (FIG. 1). As described above, the system information is obtained through system information APIs 26 (FIG. 1), and includes quantities such as processor load, available disk space, available RAM and other system parameters that influence the availability of software products. For example, the function statvfs can be used on the Solaris™ operating system to find the amount of free space for a specific file system. The system information APIs 26 may be provided through the same standard control interface 20 used by the fault monitors 32. Those skilled in the art will understand the methods and programming techniques for obtaining system information regarding the operating system 12 and the hardware 28.

In one embodiment, each resource identifier has an associated API function for obtaining information about that resource, and the function is correlated to the resource identifier through an array of function pointers. The system monitor 24, consults the system registry to determine the functions to call in order to gather the necessary information regarding the operating environment.

In step 52, the system monitor 24 (FIG. 1) then compares the gathered information to the rule set provided in the service registry. In one embodiment, the service monitor 24 gathers the information for each resource and then consults the rule set, although it will be understood by those skilled in the art that the service monitor 24 may obtain system information for one resource at a time and check for compliance with the rule set prior to obtaining system information for the next resource.

Based upon these comparisons and rules, the system monitor 24 determines, in step 54, whether a limit has been exceeded or a rule violated. If so, then the system monitor 24 proceeds to step 56 and takes corrective action. The rule set provides the corrective action to be taken for violation of each rule. For example, the rule set may provide that in the event that insufficient RAM is available that a system administrator be notified. Alternatively, for services that support dynamic re-configuration, the service could be instructed to use less RAM. As a further example, if the system monitor 24 determines that insufficient swap space is available, then the rule set may provide that system monitor 24 allocate additional swap space. The specific action is designed so as to address the problem encountered as swiftly as possible in order to ensure the high availability of the service operating upon the system. The full range of variations and alternative rule sets will be understood by those skilled in the art.

After checking each rule and taking corrective action, if necessary, the system monitor 24 enters a sleep 58 mode for a configurable amount of time to prevent the system monitor 24 from consuming too many resources.

Reference is again made to FIG. 1 in connection with the following description of the operation of an embodiment of the system 10. When initially started, the operating system 12 performs its ordinary start-up processes or routines for configuring the hardware 28 and establishing the operating environment for the system 10. In accordance with the present invention, the operating system 12 also starts the fault monitor co-ordinator 30. Throughout the duration of the system's 10 operation, the operating system 12 continues to ensure that the fault monitor coordinator 30 is restarted in the event of an unexpected failure. This is accomplished by use of a facility provided by the operating system 12 for restarting services that unexpectedly fail, as described above.

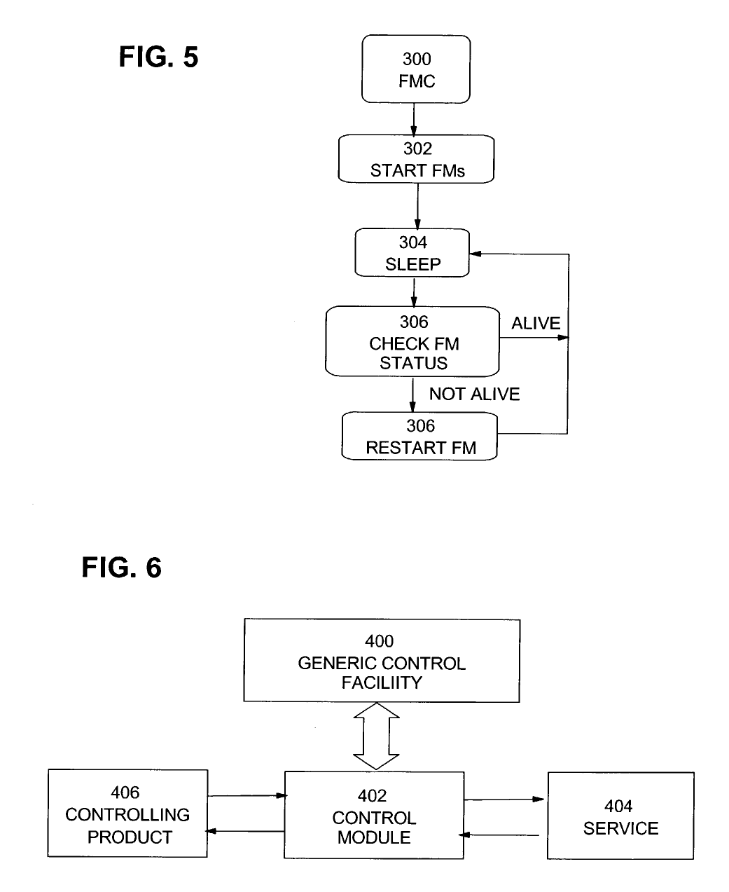

Reference is now made to FIG. 5 which shows the operation of the fault monitor co-ordinator 30 (FIG. 1) in flowchart form. Once the fault monitor coordinator 30 is started 300, it consults the service registry to determine which services to monitor and then, in step 302, it creates an instance of a fault monitor 32 (FIG. 1) for each service. The instance of a fault monitor 32 may be created as a thread or a separate process, although a separate process is preferable as a more secure embodiment. Once each fault monitor 32 is created, the fault monitor coordinator 30 will enter a sleep state 304 for a predetermined amount of time. After the predetermined amount of time elapses, in step 306 the fault monitor co-ordinator 30 checks the status of each fault monitor 32 to ensure it is alive. If any fault monitor 32 is not alive, then the fault monitor co-ordinator 30 restarts the failed fault monitor 32 in step 308. Once the fault monitor co-ordinator 30 has checked the fault monitors 32 and restarted any failed fault monitors 32, then it returns to step 304 to wait the predetermined amount of time before re-checking the status of the fault monitors 32.

Referring again to FIG. 1, the fault monitor 32d created with respect to the system monitor 24, begins by checking the status of the system monitor 24. Initially, unless started by the operating system 12, the system monitor 24 will be operable, but not alive. Accordingly, the fault monitor 32d will start the system monitor 24. The fault monitor 32d will thereafter continue to execute the processes described above with respect to FIGS. 4 and 2 to monitor the status of the system monitor 24 and ensure its availability.

Other fault monitors 32 will operate similarly. The specific actions of an individual fault monitor 32 may be tailored to the particular service it is designed to monitor. In some instances, the fault monitor 32 may not be required to start a service at boot time when the fault monitor 32 is initially created. In those cases, the fault monitor 32 may simply wait for the service to be started by a user or the primary service 14, or the fault monitor 32 for such a service may not be created until the fault monitor co-ordinator 30 recognizes that the service has been started and should now be monitored. Instructions for an individual fault monitor 32 regarding when to start or restart its associated service may be provided by the fault monitor coordinator 30, which obtains its information from the service registry entry for that particular service.

The system monitor 24 will monitor the operating environment and take corrective action, as needed, to ensure the continued healthy operation and high availability of the primary service 14 and its associated services 16, 18, as described above.

Although the present invention has been described in terms of certain actions being taken by the service monitor 22 (FIG. 1), the fault monitor 32 (FIG. 1) or the system monitor 24 (FIG. 1), such as notifying a system administrator or restarting a service, it will be appreciated that other actions may be taken and, in some circumstances, it may be prudent for no action to be taken. Likewise, although notices are described as being provided to a system administrator, notification can be made to any individual or group of individuals and may include electronic mail, paging, messaging or any other form of notification.

According to another aspect of the present invention, there is provided a generic control interface. The above-described standard control interface 20 (FIG. 1) is an embodiment of the generic control interface.

The generic control interface includes a generic control facility. The generic control facility provides a set of functions for controlling or monitoring a service or object. Reference is now made to FIG. 6, which shows the generic control facility 400 from which is created a generic control module 402 for controlling or monitoring a service 404. The amount of control or monitoring is configurable by the developer of the generic control module 402 for the specific service 404. A generic control module 402 is an interface module that contains a selected set of the functions available through the generic control facility 400, customized as necessary to the specific service 404. Also shown in FIG. 6 is a controlling product 406, which utilizes the selected functions in the generic control module 402 to control and/or monitor the service 404. In one embodiment, the controlling product 406 may be a fault monitor 32 (FIG. 1).

The generic control module 402 may be an API, a script or an executable created using the format required by the facility 400. By respecting the format, any product 406 which attempts to control the service 404 or object may do so without intimate knowledge of the details of the service 404 or object. In fact, the product 406 may be oblivious to the true nature of what it is monitoring or controlling. The details for implementing the control and monitoring functions for a specific service 404 or object are in the service or object's generic control module 402, but have been rendered generic by the use of the generic control facility 400.

The generic control module 402 can provide the controlling product 406 with a list of the generic control facility functions that are available with respect to the module's specific service 404 or object.

In one embodiment, the generic control facility 400 provides a multi-level status check function and a health probe function. These two functions are used to monitor the status of the service 404 or object. As described above with respect to the standard control interface 20 (FIG. 1), the multi-level status check function uses three indicators to determine the level of availability of a service 404: operability, aliveness and availability. The result returned by the multi-level status check function may be one of five possible states: non-operable, operable, alive, available, or unknown.

The health probe function is a function that sends a request or command to the service 404 being monitored and interprets the results, as described above. It supplements the information about the availability of the service 404 obtained through the multi-level status check function in order to obtain a more refined picture of the availability of the service 404. Once a service is determined to be available through the multi-level status check function, a heath probe can test the functionality of a particular aspect of availability by requesting that the service 404 perform some operation. The probe function returns a result that indicates whether the operation was completed by the service 404 successfully or unsuccessfully.

In a further embodiment, the generic control facility 400 includes a plurality of control functions for controlling the service 404 or object and its operating environment. The plurality of control functions may include a start function for starting the service 404, a stop function for stopping the service 404, a kill function for abruptly stopping the operation of the service 404 when unhealthy or unresponsive to a normal stop request, and a clean-up function for flushing buffers and clearing memory, as needed, once an instance of the service 404 has been killed, or cleaning up leftover resources that may have been used by the service 404.

The plurality of control functions may also include a request function. Similar in nature to the probe function, the request function is a generic functional request that can be customized as needed in the control module 402. In fact, a specific probe function may be implemented using a request function to send a functional request to the service 404. The request function may be considered a super-set of all other functions.

The health probe function and the request function incorporate numeric identifiers. For example, the controlling product 406 could call health probe number twelve or request function number seven, etc. The implementation of health probe twelve or request function seven would be provided in the control module 402. The controlling product 406 need not know what the probe or request function actually does to the service 404. Where an control module 402 features a health probe or a request function, there may also be provided a rule set. The rule set instructs the controlling product 406 as to what probes to call and when and in what circumstances to call a particular request function number. For example, if a particular health probe number fails, the rule set could specify that a particular request function number be called. In one embodiment, the rule set is provided as a file, separate from the control module 402. By way of example, a rule set may take the following form:

| Probe | I/T | Service_RC | Retries | Request |
|---|---|---|---|---|
| 1 | 50/50 | IGNORE | 3 | 12 |
| 2 | 40/50 | ANY | 37346 | 5 |
| 3 | 40/50 | IGNORE | 3 | 6 |
| 4 | 40/50 | 70 | 2 | NA |

In the above rule set, the first column corresponds to the probe ID number. The second column is the interval value and timeout value for the probe, in seconds. The interval value is the number of seconds between running this particular probe and the next action. The third column is the condition of the service specific return code that will cause action to be taken. In the above example, probes 1 and 3 ignore the code, probe 2 responds if the code is any non-zero value and probe 4 responds if the code is 70. The fourth column is the number of retries of the probe that should be taken before an action is initiated and the number of times, if appropriate, that the action should be taken. The fifth column is the ID number of the request function, if any, that corresponds to the action to be taken when a probe fails. Further or alternative content for the rule set will be understood by those skilled in the art.

The coupling of a specific probe to a specific request function implements a form of automatic problem identification and resolution. Accordingly, health or availability-related problems with a service may be identified using the multi-level status function and the health probe function and attempts may be made to resolve the problems using the coupled request function.

By encapsulating the control and monitoring actions for a particular service 404 in an associated control module 402 created using the generic control facility 400, any controlling product 406 may monitor or control the service 404 without the necessity of understanding the specific actions necessary to control the service 404. Advantageously, this provides developers of controlling products 406 with significant flexibility with respect to the ability of the controlling product 406 to control or monitor a variety of different services 404 and saves the developer the time and effort of designing specific control actions that accommodate all foreseeable services 404.

The functions provided by one embodiment are detailed below, including their syntax when implemented as an Application Programming Interface. For example, there may be provided a function for obtaining information about the control module 402 and the service 404 which it controls:

Sint gcf_getinfo (Uint iInfoType, void *opInfo, GCF_RetInfo *opResults);

The gcf_getinfo function is the first function to be called by a controlling product 406. Its main purpose is to provide the controlling product 406 with information regarding the available functionality of the control module 402. The controlling product 406 may be oblivious to the nature of the services 404 or objects that it is supposed to control or monitor, so before it can perform any control or monitoring, it must ascertain the control and monitoring functions that the control module 402 for the service 404 is designed to recognize. The first argument, iInfoType, is the type of information requested from the control module 402. When iInfoType is set to GCF_EXPORT_INFO, the second argument, *opInfo, returns a pointer to a structure called gcf_ExportInfo. This structure stores information about the control module 402 so as to enable the controlling product 406 to understand which generic control facility functions it can call with respect to the service 404.

The gcf_ExportInfo structure may take the form:

typedef struct {

| Uint32 Version; | // GCF version | |
|---|---|---|
| Uint32 Features; | // GCF module features | |
| char Description [GCF_DESCRIPTION_LENGTH]; | // | Text description of |

service

| | |
|---|---|
| GCF_MethodInfo ExportMethods; | // GCF method information |

| | |
|---|---|
| } | GCF_ExportInfo; |

In the above structure, the Version variable describes the version of the generic control facility 400 with which the control module 402 was created, the Features variable provides the ability to specify features of the module, and the Description variable provides a textual description of the service 404. The ExportMethods variable provides information about the various generic control facility functions available (exported) through the control module 402. The GCF_MethodInfo structure used for the ExportMethods variable has the following format:

typedef struct {

| | | |
|---|---|---|
| Uint64 ControlMethods; | // | pre-defined control |

functions

// available, such as start,

stop,

| | // kill, clean-up, etc. |
|---|---|
| Uint TimeOut [GCF_MAX_METHOD]; | // time out information for |

// each function

| | |
|---|---|
| } | GCF_MethodInfo; |

In the above structure for GCF_MethodInfo, ControlMethods is a bit-wise integer. Each bit represents whether a particular function is available in the control module 402. Bits 0 through 63 represent specific pre-defined control functions, such as start, stop, kill and clean-up. If a bit is turned on (1), then the function corresponding to that bit is available; whereas if the bit is turned off (0), then the function is not available. The TimeOut array provides default timeouts for each of the functions available in the control module 402. For example, bit 4 may represent the start function. If bit 4 is turned on, then the control module 402 will be responsive to a call from the controlling product 406 to start the service 404. There will be a corresponding entry in the TimeOut array that specifies how long the control module 402 will wait following an attempt to start the service 404 before determining that the service 404 is failing to respond to the start function. Of course, providing a time out is suggested, but not necessary. In fact, the controlling product may override the time out.

The gcf_getinfo function also contains an *opResults argument. This argument returns the results of the action performed by the function. The *opResults argument points to a structure within which will be indicated the success or failure of the action performed by the service 406 in response to the calling of the function. The GCF_RetInfo structure has the following format:

typedef struct {

| | |
|---|---|
| Uint GcfRc; | // the success or failure indicator |
| Sint ServiceRc; | // service specific return code; can be used to |

retrieve

// a detailed error message later

| | |
|---|---|
| } | GCF_RetInfo; |

In one embodiment, the valid values for GcfRc are:

| | |
|---|---|
| #define GCF_OK | 0 |
| #define GCF_FAILURE1 | |

Note that the information pointed to by *opResults is distinct from the return code for the function called. The above information indicates the success or failure of the action that the service 404 was requested to perform, such as starting up or performing a function like loading a webpage. The return code of a generic control facility function indicates whether there was success or failure in calling the function itself. Even if the service 404 is unable to perform the action requested, the return code for the function may indicate success because the function was successful in executing its request to the service 404. A function may fail, for example, if it needs to allocate memory before starting the service 404 and the memory allocation operation fails so it cannot complete its start request to the service 404.

The generic control facility 400 may also provide a function to translate a service specific return code into a text string so as to make the return code more easily understood for problem identification purposes. Such a function may take the form:

Sint gcf_getmsg (Uint ServiceRC, char *Message);

Once a controlling product 406 has obtained information about the control module 402 for a specific service 404 from the gcf_getinfo function, it may then initialize the control module 402 using the function gcf_init. This function takes the form:

| | | |
|---|---|---|
| Sint | gcf_init | (void *ipInstInfo, size_t ilnstLen, void **opStaticArea, |

GCF_RetInfo *opResults);

In the gcf_init function, the *ipInstInfo and iInstLen arguments define the instance of the service 404 that should be initialized. The *ipInstInfo pointer points to a memory location containing the identifying label for the instance and the iInstLen argument specifies the length of the label. The nature of the label will be specific to the service 404, and could include a text description based upon user name, or may be numeric. The *opStaticArea is a pointer to memory that can be allocated to be used by the rest of the generic control facility functions. This ensures that the control module 402 is thread safe. The pointer to the static data area should be stored outside of the control module 402 and passed into each generic control facility function. As discussed above, the *opResults argument returns the results of the function action called. For the gcf_init function, the action may include performing any initialization operations required by the service 404 to be controlled, such as allocating memory or opening an error logging file. The specific actions performed by the gcf_init function will be customized by the developer of the control module 402 depending upon the service 404 to be controlled.

Another function that may be provided by the generic control facility 400 is a control module reset function. This function is typically used to free memory after a generic control facility function has timed out. If a function times out and control is returned to the calling code, a resource such as memory or a file descriptor could have been leaked. For example, if a start function is called and it times out, memory may have been allocated for use by the service which will remain allocated unless those resources are freed using a reset function. One of the uses of the static data area is to enable a control module 402 developer to track the resources allocated by a generic control facility function so as to use the reset function to free them. The reset function may take the form:

Sint gcf_reset (void *ipStaticArea, GCF_Retinfo *opResults);

The last function to be called by a controlling product 406 would be a function that finishes the use of the control module 402, and thus frees any resources being tracked in the static data area and frees the static data area. Such a function can take the form:

| | | |
|---|---|---|
| Sint | gcf_init | (void *ipInstInfo size_t linstLen, void lipStaticArea, |

GCF_RetInfo *opResults);

The four above functions enable a controlling product 406 to gather information about a control module 402, initialize the control module 402, reset the control module 402 and finish using the control module 402. Other generic control facility functions are directed to the control and monitoring of the service 404. For example, a start function could be provided for starting an instance of the service 404 to be controlled or monitored:

| | | |
|---|---|---|
| Sint | gcf_start | (void *ipInstInfo, size_t ilnstLen, GCF_PartInfo *iopPart, |

Uint iPartCount, void *ipData, size_t iDataSize, void
*ipStaticArea, GCF_RetInfo *opResults);

In the above function, the first two arguments, *ipInstInfo and iInstLen, pass information about the instance of the service 404 to be started, as described above. In the event that the service uses partitions, the third and fourth arguments may be used to pass a list of partitions and the number of elements in the list of partitions, respectively. If a list of partitions is passed into gcf_start, the results for starting the individual partitions will be returned in the *iopPart list, rather than through opResults. The fifth and sixths arguments, *ipData and iDataSize, provide the control module 402 with any specific information that may be required by the control module 402, such as a path to a configuration file for the service 404 or any other specific information that the controlling product 406 has about how it wants the service 404 to perform the start-up. This data is intended for the use of the service 404 and not the control module 402. For example, if the service 404 is capable of a fast start or a more complex slow start and the controlling product 406 is aware of this capability, then the controlling product 406 may request a particular type of start from the service 404. The static data pointer is also passed in the gcf_start function, although it may not be used. The results of the start operation are passed back through the *opResults argument, if no partition list is included. In the case where partitions are involved, the *opResults argument may still contain information regarding the success or failure of the operation, in a summary form. For example, it may indicate a failure if the action fails on one or more partitions.

The GCF_PartInfo structure has the following form:

typedef struct {

| | |
|---|---|
| Uint Number; | // partition number |
| GCF_Retinfo PartResults | // results |

| | |
|---|---|
| } | GCF PartInfo; |

A function may also be provided for stopping an instance of a service 404, having the following form:

| | | |
|---|---|---|
| Sint | gcf_stop | (void *ipInstInfo, size_t ilnstLen, GCF_PartInfo *iopPart, |

Uint iPartCount, void *ipData, size_t iDataSize, void
*ipStaticArea, GCF_RetInfo *opResults);

Note that the gcf_stop function has the same arguments as the gcf start function. Also having the same arguments would be gcf_kill and gcf_cleanup. The particular details of what needs to be done to start, stop, kill or cleanup after a particular service are left to the control module 402 developer to customize to a particular service 404. Encapsulating these functions in the generic control facility format facilitates control over a particular service 404 by any controlling product 406 without the designer of the controlling product 406 requiring intimate knowledge of the service 404.

The generic control facility 400 may further provide a multi-level status checking function, for determining the status of the service 404. As described above, the status checking function may return one of five results: not operable, operable, alive, available, or unknown. Other levels of availability or sub-levels within the foregoing categories, will be understood by those skilled in the art. Through this function the controlling product 406 will discover whether the service 404 is capable of being started, is started, and/or is available to receive requests. The function may be of the form:

| | | |
|---|---|---|
| Sint | gcf_getstate | (void *ipInstInfo size_t iInstLen, GCF_PartInfo *iopPart, |

Uint iPartCount, void *ipData size_t iDataSize, void
*ipStaticArea, GCF_RetInfo *opState);

Note that the gcf_getstate function contains the same arguments as the specific service control functions, like gcf_start and gcf_stop, except that instead of returning results in the *opResults argument, results are returned in the *opState argument. The result returned is one of the five possible states, which may be defined as follows:

| | | |
|---|---|---|
| #define GCF_NOT_OPERABLE | 0 | // not properly installed, etc. |
| #define GCF_OPERABLE | 1 | // installed properly but not alive |

yet

| | | |
|---|---|---|
| #define GCF_ALIVE | 2 | // alive but not available |
| #deflne GCF_AVAILABLE | 3 | // should be available for requests |
| #deflne GCF_UNKNOWN | 4 | // state is unknown |

Once the state of a service 404 is determined to be “available”, the controlling product 406 may seek further information about whether the service 404 is operating properly. For this purpose, the generic control facility 400 provides a health probe function, having the form:

| | | |
|---|---|---|
| Sint | gcf_probe | (Uint iProbeId, void *ipInstInfo size_t iInstLen, |

GCF_PartInfo *iopPart, Uint iPartCount, void *ipData
size_t iDataSize, void *ipStaticArea, GCF_RetInfo
*opResults);

In the above gcf_probe function, the specific probe being called is identified by the iProbeId number. In one embodiment, the iProbeId number is a thirty-two bit integer, providing over four billion possible probe functions. Success or failure of the probe is returned in the *opResults argument. The specific action performed by a particular probe to test a particular aspect of a the service 404 is determined by the developer of the control module 402, as described above with respect to the fault monitor system.

Somewhat similar to the gcf _probe function, the generic control facility 400 may provide a customizable request function that may be tailored by the developer of a control module 402 to send any command or request to the service 404 being controlled. The request function may be defined as follows:

| | | |
|---|---|---|
| Sint | gcf_request | (Uint iCommand, void *ipInstInfo, size_t iInstLen, |

GCF_PartInfo *iopPart, Uint iPartCount, void *ipData,
size_t iDataSize, void *ipStaticArea, GCF_RetInfo
*opResults, void *opResponse, size_t
*iopResponsesize);

The iCommand argument provides an identification number for a specific implementation of a request, much like iProbeId. As before, the success or failure of the requested action is passed back through the *opResults argument. The actual results of the request response may be passed back through the *opResponse argument. The type of data returned will depend upon the implementation of the request command. For example, a request may ask for particular data from a service 404 and that data may be passed back using the *opResponse pointer. The gcf_request function can be considered a super-set of all the other functions. Like with the gcf_probe function, the purpose and implementation of any particular gcf_request function is left up to the developer of the control module 402.

Outlined below is a sample implementation of a control module 402 according to the present invention. As will be understood by those skilled in the art, the control module begins with the inclusion of appropriate libraries, including gcf.h. The format of the StateInfo structure is then defined, as are various time out values. The control module 402 shown below then features a customized implementation of each generic control facility function. In the simple control module 402 shown below, the implementation of the gcf_start command, for example, includes an instruction setting the return code to ECF_OK, a system call “serv_start” to instructing the system to start the service, and an instruction returning the return code. The implementation of the gcf_stop and gcf_kill commands are similar.

The implementation of the gcf_getstate command is designed to determine whether the service is available. For simplicity, the implementation shown below presumes the service is operable and then seeks to determine if it is started, in which case it assumes that it is available. In order to determine if the service is started, the command attempts to open “/tmp/server_lockfile”. If the file is locked, then the service has been started and has locked the file, so the opResults pointer is set to GcfRc, which is set to indicate the service is available.

The sample control module 402 shown below also contains a customized implementation of the gcf_getinfo command.

A simple control module 402, in accordance with the present invention, may be implemented as follows:

#include <errno.h>
#include <sys/types.h>
#include <sys/stat.h>
#include <fcntl.h>
#include “gcf.h”
#include “osserror.h”
#include “osslog.h”
#include “ossmemory.h”
#include “commoncodes.h”
#include “gcffuncdefs.h”
#include “ossefuncdefs.h”
typedef struct State Info {

Uint StartCount;
Uint StopCount;
Uint KillCount;
Uint CleanupCount;
Uint StateCount;
Uint State;

}StateInfo_t;
#define START_TIMEOUT 5
#define STOP_TIMEOUT 5
#define KILL_TIMEOUT 5
#define STATE_TIMEOUT 5

| | | |
|---|---|---|
| Sint gcf_init( | void | * ipInstinfo size_t iInstLen, |

| | |
|---|---|
| void | **oppStaticArea, |

GCF_RetInfo * opResults)

{

Sint rc = ECF_OK;
Sint mainRC = ECF_OK;
opResults−>GcfRc = GCF_OK;
// Set the static area pointer (we don't need it)
*oppStaticArea = NULL;
exit:
return mainRC;

}

| | | |
|---|---|---|
| Sint gcf_fini( | void | * ipInstinfo size_t iInstLen, |

| | |
|---|---|
| void | **oppStaticArea, |

GCF_RetInfo * opResults)

{

Sint mainRC = ECE_OK;
return mainRC;

}

| | |
|---|---|
| Sint gcf_start( void | * ipInstInfo size_t iInstLen, |

| GCF_PartInfo * iopPart, Uint iPartCount, | |
|---|---|
| void | * ipData, size_t iDataSize, |
| void | * ipStaticArea, |

GCF_RetInfo * opResults)

{

Sint rc = ECE_OK;
system(“serv_start”);
return rc;

}

| | |
|---|---|
| Sint gcf_stop( void | * ipInstInfo size_t iInstLen, |

| GCF_PartInfo * iopPart, Uint iPartCount, | |
|---|---|
| void | * ipData, size_t Data Size, |
| void | * ipStaticArea, |

GCF_RetInfo * opResults)

{

Sint rc = ECF_OK;
system(“serv_stop”);
return rc;

}

| | |
|---|---|
| Sint gcf_kill( void | * ipinstinfo size_t iInstLen, |

| GCF_PartInfo * iopPart, Uint iPartCount, | |
|---|---|
| void | * ipData, size_t iDataSize, |
| void | * ipStaticArea, |

GCF_RetInfo * opResults)

{

Sint rc = ECF_OK;
opResults−>GcfRc = GCF_OK;
system(“serv_kill”);
return rc;

}

| | |
|---|---|
| Sint gcf_getstate( void | * ipInstinfo, size_t iInstLen, |

| GCF_PartInfo * iopPart, Uint iPartCount, | |
|---|---|
| void | * ipData, size_t iDataSize, |
| void | * ipStaticArea, |

GCF_RetInfo * opResults)

{

Sint rc = ECF_OK;
int lockFD = −1;
opResults−>GcfRc = GCF_OPERABLE;
lockFD = open(“/tmp/server_lockfile”, O_RDWR);
if( lockFD < 0)
{

goto exit;

}
// If this file is locked, then the service is started (and has it locked)
if (lockf(lockFD, F_TEST, 0 ) == −1 &&

(errno == EACCES ∥
errno == EAGAIN )
)

{

opResults−>GcfRc = GCF_AVAILABLE;

}
if (lockFD > 0)

close(lockFD);
exit:
return rc;

}
Sint gcf_getinfo( Uint iInfoType, void * opInfo,

GCF_RetInfo * opResults)

{

Sint rc = ECF_OK;
// Set the required export information
if (iInfoType == GCF_EXPORT_INFO)
{

GCF_ExportInfo ExportInfo;
memset(&ExportInfo, 0, sizeof(ExportInfo));
ExportInfo.Version = 1;
ExportInfo.Features = 0;
strcpy(ExportInfo.Description, “Sample GCF module”);
ExportInfo.ExportMethods.ControlMethods =

GCF_INIT|GCF_FINI|GCF_START|GCF_STOP|GGF_KILL|
GCF_GET_STATE|GCF_GET_INFO|GCF_RESET;

ExportInfo.ExportMethods.TimeOut[GCF_INIT] = 0;
ExportInfo.ExportMethods.TimeOut[GCF_FINI] = 0;
ExportInfo.ExportMethods.TimeOut[GCF_START] = START_TIMEOUT;
ExportInfo.ExportMethods.TimeOut[GCF_STOP] = STOP_TIMEOUT;
ExportInfo.ExportMethods.TimeOut[GCF_GET_STATE] = STATE_TIMEOUT;
*((GCFExportInfo*)opInfo) = ExportInfo;
opResults−>GcfRc = GCF_OK;

}
else
{

rc = ECE_GCF_UNKNOWN_INFORMATION_TYPE;

}
exit:
return rc;

}

| | |
|---|---|
| Sint gcf_reset( void | * ipStaticArea, |

GCF_RetInfo * opResults)

{

Sint mainRC = ECF_OK;
opResults−>GcfRc = GCF_OK;
return mainRC;

}

The generic control interface may be advantageously employed in the context of a clustered environment. Cluster management software often needs to monitor and/or control a variety of services on multiple computer systems within the cluster. Accordingly, the generic control interface may provide a useful and efficient method and system for controlling or monitoring those services.

The present invention may provide a generic control facility for creating a control module for each specific service that encapsulates the control commands or actions for a specific service in generic functions. Through such a control module, a controlling product may advantageously control or monitor a service without requiring intimate knowledge of the service. A control and monitoring facility according to the present invention may provide the benefit of multi-level status information regarding a service. Such a facility may also provide flexible customized control functions with respect to the service.

Using the foregoing specification, the invention may be implemented as a machine, process or article of manufacture by using standard programming and/or engineering techniques to produce programming software, firmware, hardware or any combination thereof.

Any resulting program(s), having computer readable program code, may be embodied within one or more computer usable media such as memory devices, transmitting devices or electrical or optical signals, thereby making a computer program product or article of manufacture according to the invention. The terms “article of manufacture” and “computer program product” as used herein are intended to encompass a computer program existent (permanently, temporarily or transitorily) on any computer usable medium.

A machine embodying the invention may involve one or more processing systems including, but not limited to, central processing unit(s), memory/storage devices, communication links, communication/transmitting devices, servers, I/O devices, or any subcomponents or individual parts of one or more processing systems, including software, firmware, hardware or any combination or sub-combination thereof, which embody the invention as set forth in the claims.

One skilled the art of computer science will be able to combine the software created as described with appropriate general purpose or special purpose computer hardware to create a computer system and/or computer sub-components embodying the invention and to create a computer system and/or computer sub-components for carrying out the method of the invention.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A control module for use by a controlling product in controlling or monitoring a service on a computer system, said control module comprising:
a plurality of functions, each function being responsive to a generic call from the controlling product, and wherein said functions include a multi-level status check function for determining a level of availability of the service and assigning a status indicator of said level of availability, said status indicator having at least three levels,
said levels including a first level that indicates that the service is available to receive requests, a second level that indicates that the service is in a mode of operation in which it is unable to take requests, and a third level that indicates that the service is not an active process on the computer system.

2. The control module claimed in claim 1, wherein said status check function includes aliveness testing instructions for determining whether the service is an active process on the computer system, and availability testing instructions for determining whether the service is in a mode of operation in which it is unable to take requests.

3. The control module claimed in claim 2, wherein the computer system includes memory, and wherein said aliveness testing instructions include instructions for determining if an active instance of the service is present in said memory on the computer system.

4. The control module claimed in claim 2, wherein said availability testing instructions include instructions for determining if an active instance of the service is operating in an unavailable mode.

5. The control module claimed in claim 4, wherein said unavailable mode includes a maintenance mode.

6. The control module claimed in claim 4, wherein said unavailable mode includes a crash recovery mode.

7. The control module claimed in claim 1, wherein said levels further include a fourth level that indicates that the service is not operable on the computer system and is incapable of being started.

8. The control module claimed in claim 7, wherein said status check function includes operability testing instructions for determining whether the service is capable of being started on the computer system.

9. The control module claimed in claim 8, wherein said operability testing instructions include instructions for determining if a start command for the service is present on the computer system.

10. The control module claimed in claim 1, wherein said plurality of functions further include a health probe function for testing an aspect of the functionality of the service, said health probe function including an instruction to the service to perform an operation, and a return parameter that indicates the success of said operation, and wherein said health probe function is operable when said service is at said first level of availability.

11. The control module claimed in claim 10, further including a rule set, said rule set including at least one entry identifying at least one health probe function to be called by the controlling product, said rule set being accessible to the controlling product.

12. The control module claimed in claim 10, wherein said plurality of functions further include a request function for requesting a specific action by the service, said request function including an instruction to the service to perform a specific action and a response parameter containing the results of said specific action.

13. The control module claimed in claim 12, further including a rule set, said rule set including at least one entry identifying at least one health probe function to be called by the controlling product and at least one request function to be called by the controlling product in response to a condition of said return parameter, said rule set being accessible to the controlling product.

14. The control module claimed in claim 1, wherein said plurality of functions further include a start function for starting an instance of the service and a stop function for stopping an instance of the service

15. The control module claimed in claim 14, wherein said plurality of functions further include a kill function for stopping an unresponsive instance of the service and a clean-up function for freeing system resources allocated to a stopped or killed instance of the service.

16. The control module claimed in claim 1, wherein each one of said plurality of functions is responsive to a corresponding generic call from the controlling product and each of said functions includes instructions specific to the service for implementing the function.

17. The control module claimed in claim 16, wherein said plurality of functions further include an identification function for providing the controlling product with information regarding said plurality of functions.

18. A system for controlling an monitoring a service on a computer system, said system comprising:
a controlling product;
a control module, said control module including a plurality of functions, each function being responsive to a generic call from said controlling product, and wherein said functions include a multi-level status check function for determining a level of availability of the service and assigning a status indicator of said level of availability, said status indicator having at least three levels,
said levels including a first level that indicates that the service is available to receive requests, a second level that indicates that the service is in a mode of operation in which it is unable to take requests, and a third level that indicates that the service is not an active process on the computer system.

19. A control module for use by a controlling product in controlling or monitoring a service on a computer system, said control module comprising:
a plurality of functions, each function being responsive to a generic call from said controlling product, and wherein said functions include,
(a) a health probe function for testing an aspect of the functionality of the service, said health probe function including an instruction to the service to perform an operation, and a return parameter that indicates the success of said operation, and
(b) a request function for requesting a specific action by the service, said request function including an instruction to the service to perform a specific action and a response parameter containing the results of said specific action; and
a rule set, said rule set including at least one entry identifying at least one health probe function to be called by the controlling product and at least one request function to be called by the controlling product in response to a condition of said return parameter, said rule set being accessible to the controlling product.

20. A method for controlling or monitoring a service by a controlling product on a computer system, the computer system including a control module having a plurality of functions including a multi-level status check function, said method comprising the steps of:
determining a level of availability of the service; and
assigning a status indicator of said level of availability, said status indicator having at least three levels, said levels including a first level that indicates that the service is available to receive requests, a second level that indicates that the service is in a mode of operation in which it is unable to take requests, and a third level that indicates that the service is not an active process on the computer system.

21. The method claimed in claim 20, wherein said step of determining includes determining whether the service is an active process on the computer system and determining whether the service is in a mode of operation in which it is unable to take requests.

22. The method claimed in claim 20, wherein said levels further include a fourth level that indicates that the service is not operable on the computer system and is incapable of being started.

23. The method claimed in claim 22, wherein said step of determining includes determining whether the service is an active process on the computer system, determining whether the service is in a mode of operation in which it is unable to take requests, and determining whether the service is capable of being started on the computer system.

24. The method claimed in claim 23, wherein said step of determining whether the service is capable of being started includes determining if a start command for the service is present on the computer system.

25. The method claimed in claim 23 wherein the computer system includes memory and said step of determining whether the service is an active process includes determining if an active instance of the service exists in memory on the computer system.

26. The method claimed in claim 20, further including a step of calling a health probe function to test an aspect of functionality when said level of availability is said first level, said health probe function including an instruction to the service to perform an operation, and a return parameter that indicates the success of said operation.

27. The method claimed in claim 26, wherein said computer system further includes a rule set, said rule set including at least one entry identifying at least one health probe function to be called by the controlling product in the step of calling a health probe.

28. The method claimed in claim 27, further including a step of calling a request function in response to a condition of said return parameter, said request function including an instruction to the service to perform a specific action and a response parameter containing the results of said specific action.

29. The method claimed in claim 28, wherein said rule set entry further includes at least one request function to be called by the controlling product in response to a condition of said return parameter.

30. A computer program product comprising a computer readable medium carrying program means for controlling and monitoring a service through a controlling product, the program means including,
code means for providing a plurality of functions, each function being responsive to a generic call from the controlling product, and wherein said functions include a multi-level status check function for determining a level of availability of the service and assigning a status indicator of said level of availability, said status indicator having at least three levels,
said levels including a first level that indicates that the service is available to receive requests, a second level that indicates that the service is in a mode of operation in which it is unable to take requests, and a third level that indicates that the service is not an active process on the computer system.

31. A computer program product comprising a computer readable medium carrying program means for controlling or monitoring a service by a controlling product on a computer system, the program means including:
code means for determining a level of availability of the service; and
code means for assigning a status indicator of said level of availability, said status indicator having at least three levels, said levels including a first level that indicates that the service is available to receive requests, a second level that indicates that the service is in a mode of operation in which it is unable to take requests, and a third level that indicates that the service is not an active process on the computer system.

32. The computer program product claimed in claim 31, wherein said code means for determining includes code means for determining whether the service is an active process on the computer system and determining whether the service is in a mode of operation in which it is unable to take requests.

33. The computer program product claimed in claim 31, wherein said levels further include a fourth level that indicates that the service is not operable on the computer system and is incapable of being started.

34. The computer program product claimed in claim 33, wherein said code means for determining includes code means for determining whether the service is an active process on the computer system, determining whether the service is in a mode of operation in which it is unable to take requests, and determining whether the service is capable of being started on the computer system.

35. The computer program product claimed in claim 34, wherein said code means for determining whether the service is capable of being started includes code means for determining if a start command for the service is present on the computer system.

36. The computer program product claimed in claim 34 wherein the computer system includes memory and said code means for determining whether the service is an active process includes code means for determining if an active instance of the service exists in memory on the computer system.

37. The computer program product claimed in claim 31, further including code meas for calling a health probe function to test an aspect of functionality when said level of availability is said first level, said health probe function including an instruction to the service to perform an operation, and a return parameter that indicates the success of said operation

38. The computer program product claimed in claim 37, further including code means for providing a rule set, said rule set including at least one entry identifying at least one health probe function to be called by the controlling product in the step of calling a health probe.

39. The computer program product claimed in claim 38, further including code means for calling a request function in response to a condition of said return parameter, said request function including an instruction to the service to perform a specific action and a response parameter containing the results of said specific action.

40. The computer program product claimed in claim 39, wherein said rule set entry further includes at least one request function to be called by the controlling product in response to a condition of said return parameter.
